(19) United States
(12) Patent Application Publication
(10) Pub. No.: US 2026/0141312 A1
(43) Pub. Date: May 21, 2026

(54) UNIFIED IOT EDGE FRAMEWORK FOR LIFECYCLE MANAGEMENT OF ARTIFICIAL INTELLIGENCE SOLUTIONS ACROSS MULTIPLE IOT EDGE DEVICES

(71) Applicant: Zededa Inc., San Jose, CA (US)

(72) Inventors: Pandi Chandran Pitchai, Bangalore (IN); Hariharasubramanian Cinthamani Sankaran, Cupertino, CA (US)

(21) Appl. No.: 19/267,606

(22) Filed: Jul. 13, 2025

Related U.S. Application Data
(60) Provisional application No. 63/722,011, filed on Nov. 18, 2024.

(51) Int. Cl. G06N 20/20; G06F 21/31; G06T 1/20

(52) U.S. Cl. CPC G06N 20/20; G06F 21/31; G06T 1/20

(57) ABSTRACT

A computer-implemented method may be used to implement artificial intelligence (AI) over an Internet of Things (IoT) Edge Network. The method may include, at one or more storage devices, storing an AI model. The method may further include, at one or more hardware processing devices, using the AI model to develop an AI Edge Solution suitable for achieving a business purpose through the IoT Edge Network. The method may further include, at one or more communication devices, deploying the AI Edge Solution to a plurality of Edge Computing Devices within the IoT Edge Network.

### RELATED APPLICATIONS

This application claims the benefit of U.S. Provisional Patent Application Ser. No. 63/722,011, filed on Nov. 18, 2024 and entitled “Unified IoT Edge Framework for Lifecycle Management of Artificial Intelligence Solutions across Multiple IoT Edge Devices.” The foregoing is incorporated by reference as though set forth herein in its entirety.

### TECHNICAL FIELD

The present document relates to techniques for lifecycle management of artificial intelligence solutions across multiple IoT Edge devices.

### BACKGROUND

A “Distributed Edge” may be a network in which client data is processed at the periphery of the network, for example, close to the origin of the data. An “Edge Computing Device” may be a device that provides an entry point into an enterprise or service provider core network such as a Distributed Edge. An Edge Computing Device in a Distributed Edge may be referred to as a Distributed Edge Device.

An Internet of Things gateway, or “IoT gateway,” is one type of Edge Computing Device, and may be a physical device and/or virtual platform that connects sensors, IoT modules, and/or smart devices to a network such as the Internet. An IoT gateway may collect and/or transmit data to other devices in the network. An “Edge Orchestrator” may be a hardware and/or software resource that manages and/or coordinates the flow of resources between multiple types of devices, infrastructure, and network domains in a Distributed Edge.

### SUMMARY

The number of IoT (Internet of Things) devices connected to the Internet is growing rapidly. These devices generate massive amounts of data from sensors, which may overwhelm existing upload bandwidth. In many cases, sending all this data to the cloud for processing may be prohibitively expensive and may also be too slow. In time-sensitive scenarios like self-driving cars, relying on cloud-based analysis may not be practical, as it introduces significant delays.

### Edge Computing

Edge Computing attempts to address these challenges by processing data locally, close to its source, without needing to send everything to the cloud. Such an approach may reduce latency and bandwidth strain while also protecting sensitive data that may have privacy, intellectual property, or legal implications.

### Artificial Intelligence

Artificial Intelligence (AI) is gaining momentum due to recent advancements in Large Language Models (LLM), the advent of recent techniques to fine-tune, quantize (for example, with techniques such as Activation-Aware-Quantization and Low Rank), and/or prune the LLMs to arrive at fine-tuned, downsized SLMs, and the availability of increased computing capacity and access to hardware accelerators to speed up AI training and inferencing. In particular, AI is effective at learning from patterns of Big Data and applying that learning to predict or classify new data.

### Internet of Things (IoT) Edge AI

Applying Artificial Intelligence at the Edge using the Edge Computing paradigm yields Edge Artificial Intelligence (Edge AI). Edge AI enables AI that may operate on local devices rather than relying on cloud computing. Some possible use cases for such an approach may include, for example and without limitation:
IoT Gateways: Edge AI may be useful for enabling IoT Edge Gateways, as it allows them to perform data processing and decision-making locally without relying on cloud services. This may reduce latency, conserve bandwidth, and/or enhance privacy and security.
Autonomous Vehicles: Edge AI may enable autonomous vehicles to process data from sensors such as cameras, LiDAR, and/or radar in real-time to make driving decisions without needing to rely heavily on cloud connectivity, which may not always be available.
Smart Cameras and Surveillance Systems: Edge AI may be used in smart cameras and surveillance systems to detect and recognize objects, faces, gestures, and/or events in real-time, allowing for quicker responses to potential security threats.
Industrial Automation: Edge AI may be used in industrial automation for predictive maintenance, quality control, and/or process optimization. By analyzing data from sensors and machinery locally, Edge AI can identify anomalies, predict failures, and optimize production processes in real-time.
Healthcare Monitoring Devices: Edge AI may be deployed in wearable health monitoring devices to analyze vital signs, detect abnormalities, and provide real-time feedback to users without the need for constant internet connectivity. Additionally, Edge AI may be deployed on diagnostic platforms such as MRI or CT scanners, where the scan images are analyzed by AI to automatically classify the images (for example, as positive or negative), trigger local validation or approval, and/or otherwise aid in diagnosis.
Retail Analytics: Edge AI can analyze in-store customer behavior, monitor inventory levels, and provide personalized shopping experiences without relying on cloud services. This may enable retailers to optimize store layouts, manage inventory more effectively, and offer personalized promotions in real-time.
Smart Home Devices: Edge AI may be used in smart home devices such as voice assistants, smart thermostats, and security systems to process voice commands, adjust settings, and detect anomalies locally without relying on constant cloud connectivity.
Agriculture: Edge AI may be used in agriculture for crop monitoring, pest detection, and/or irrigation control. By analyzing data from sensors and drones locally, Edge AI can provide farmers with real-time insights and recommendations to optimize crop yields and reduce resource usage.
Energy Management: Edge AI can optimize energy usage in buildings and smart grids by analyzing data from sensors and meters locally. Local analysis in this manner enables real-time monitoring, predictive maintenance, and demand response to improve energy efficiency and reduce costs.
Methane Leak Detection and Minimizing Impact on Climate: Edge AI enables real-time processing of data from sensors placed around facilities to detect leaks (such as, for example, methane leaks) quickly. Advanced algorithms can analyze infrared camera feeds and/or sensor data on-site to identify leaks, reducing the latency of detection compared to cloud-based solutions. Upon detecting a leak, Edge AI systems can trigger immediate responses, such as shutting off valves, adjusting processes, and/or alerting maintenance teams. This rapid response can minimize the volume of methane released into the atmosphere.

One skilled in the art will recognize that the above list of use cases for Edge AI across various industries is merely exemplary, and that many other uses are feasible.

Deployment and management of Edge AI at scale may face many challenges and obstacles, such as the following:
Limited Resources: Edge devices often have limited computational power, memory, and storage capacity compared to cloud servers. Deploying AI models on these resource-constrained devices may benefit from careful optimization and consideration of model size and complexity.
Data Quality and Quantity: Edge AI applications rely on high-quality and relevant data for training and inference. Ensuring the availability of sufficient and diverse data at the Edge can be challenging, especially in remote or constrained environments.
Security and Privacy: Edge devices are often deployed in distributed and uncontrolled environments, making them vulnerable to security threats such as unauthorized access, data breaches, and tampering. Implementing robust security measures, including encryption, authentication, and access control, may help protect sensitive data and ensure user privacy.
Interoperability and Compatibility: Edge AI applications may need to interact with a variety of devices, sensors, protocols, and platforms. Ensuring interoperability and compatibility across different hardware and software components can be complex and may lead to significant standardization and integration efforts.
Lifecycle Management: Managing Edge AI applications throughout their lifecycle, including deployment, updates, monitoring, and maintenance, can be challenging, especially in large-scale deployments with heterogeneous devices and environments. Implementing effective version control, automated testing, and deployment pipelines may help ensure application reliability and performance.
Reliability and Resilience: Edge devices operate in diverse and often harsh environments with fluctuating network conditions, power outages, and hardware failures. Designing resilient and fault-tolerant Edge AI applications that can gracefully handle disruptions and recover from failures may help ensure continuous operation and minimize downtime.
Regulatory and Compliance Requirements: Edge AI applications may be subject to various regulatory and compliance requirements, including data protection, privacy regulations, and industry standards. Ensuring compliance with applicable laws and regulations, such as GDPR, HIPAA, and PCI DSS, may be done by paying careful attention to data handling practices, consent mechanisms, and auditing capabilities.
Cost and Scalability: Deploying and managing Edge AI applications can involve significant upfront and ongoing costs, including hardware procurement, software development, maintenance, and support. Balancing performance, scalability, and cost-effectiveness while meeting application requirements and user expectations may help maximize ROI and minimize total cost of ownership.

### IoT Edge AI Application Lifecycle

Many of the technical challenges associated with the above issues revolve around managing the lifecycle of Edge AI models.

Referring now to FIG. 3, there is shown a block diagram 300 depicting, at a high level, the major phases in the lifecycle of an Edge AI application, according to one embodiment. Such phases may include, but are not limited to, the following:
A Development Phase 310;
A Training Phase 320;
A Packaging and Deployment Phase 330;
An Automation and Management Phase 340;
A Monitoring Phase 350; and
A Retraining Phase 360.

These phases will be described in greater detail below.

### Development Phase 310

The Development Phase 310 may include steps such as:
Identifying the use case for the Edge AI Application;
Identifying the input dataset requirements;
Arriving at the right set of features through feature engineering;
Identifying the right ML algorithm for the use case;
Setting up training and testing datasets; and
Identifying the performance criteria for the ML model.

### Training Phase 320

Referring now to FIG. 4, there is shown a block diagram 400 depicting some steps that may be involved in the Training Phase 320 for ML training, according to one embodiment. Such steps may include additional optional steps such as:
Collecting datasets 410 from the field;
Synthesizing 420 to increase dataset size (optional);
Labeling datasets 430, for example, by integrating third party solutions such as Label Studio for automated labeling techniques;
Extracting features 440 from the datasets using pre-processing techniques such as DSP, image resizing, and the like;
Training the AI model 450 using the training dataset;
Testing the accuracy of the model 460 using the test dataset ;
Compressing the model 470 for lower resource usage including compute and memory;
Using quantization techniques to reduce model size 480; and
Optimizing the model 490 using hardware-specific SDKs like TensorRT, OpenVino, Apache TVM, and/or the like.

### Packaging and Deployment Phase 330

Referring now to FIG. 5A, there is shown a block diagram 500 depicting steps that may be involved in ML model packaging as part of the Packaging and Deployment Phase 330, according to one embodiment. Such steps may include additional optional steps such as:
Once the training and optimization is complete, versioning the model 510;
Uploading the model to a Model Repository 520 with weights, feature schema, neural schema, and the like;
Generating a model service definition 530 by writing a service file for packaging the model for ML serving (using ML serving frameworks such as Chassis.ml, BentoML, Modzy, or the like);
Containerizing the model 540 by packaging the model using the service file as a container and pushing it to a container repository; and
Versioning the model 544 to align with the ML Model version.

Referring now to FIG. 5B, there is shown a block diagram 550 depicting steps that may be involved in Edge AI Deployment as part of the Packaging and Deployment Phase 330, according to one embodiment. Such steps may include additional optional steps such as:
Developing the Edge AI business case 560 by developing the business logic around running the ML model, for example, via substeps 561, 562, 563, 564, 565, and 566 below:
   Including logic around input collection 561;
   Pre-processing steps 562;
   Invoking the ML model 563 over gRPC/REST API interfaces;
   Processing the inference outcome 564;
   Acting on the inference outcome 565 (actuators, message to cloud);
   Sampling input/output 566 for Cloud or federated training;
Once the business logic is finalized, developing the application 570;
Defining the solution 580 by packaging the business app along with ML Model Service App in the form of a solution; and
Deploying the solution 590 by rolling out the solution to Edge devices.

### Automation and Management Phase 340

After initial deployment of the Edge AI solution, through Continuous Integration and Continuous Delivery (CI/CD) and Continuous Monitoring (CM), the model and the containers are continuously monitored for performance, and then updated with improvements and fixes in a central location.

Based on the model performance, the model may undergo fine-tuning (LLM) or retraining (Traditional ML models), and the other containers may be enhanced with bug fixes.

After the improvements are made, a new version of the containers and model may be published. The new version of the model may be pushed to the central model registry, and the new version of the containers may be pushed to container storage platforms such as Open Container Initiative (OCI) compliant repositories.

Through Continuous Integration, when the versions of the model and container are updated in a central repository such as GitLab or GitHub, the deployments may be updated automatically by pushing the updated versions down to the Edge devices for release upgrade.

### Monitoring Phase 350

The Monitoring Phase 350 may operate continuously and may facilitate Edge AI deployments, as business decisions are taken based on ML inferences. Such monitoring may include continuous checking of drifts in inputs and recalls. In at least one embodiment, an F1 score may be used for such monitoring. A separate service app may be provided for pulling ML metrics from an ML Service App.

In at least one embodiment, the monitoring service may be packaged along with the AI Model Service App and/or AI Business App. Metrics may be uploaded to ML Monitoring applications such as Arize.com, Censius, Whylabs, and/or the like, for setting up dashboards, monitors, and/or the like.

### Retraining Phase 360

The retraining phase 360 may be performed, optionally with upgrades to the operation of the business app and/or the ML Model Service App. The retraining phase 360 may include planning for ML model improvements based on triggers from the monitoring solution. The retraining phase 360 may include, for example:
Addressing issues with drifts, false positives, and/or false negatives;
Gathering ground truth and uploading fresh datasets;
Retraining the model with additional datasets;
Completing compression and optimization;
Uploading a new version of the ML model;
Upgrading the solution version; and/or
Rolling out the new solution to Edge devices.

In at least one embodiment, these different stages of the lifecycle may be managed using a single, unified Edge AI framework. The described system and method thus provide improvements over solutions that target one or more stages of the life cycle, without interacting with other frameworks to establish a unified workflow.

In at least one embodiment, a flexible and modular framework is implemented, which enables integration of various components relevant for an IoT Edge AI model lifecycle. The system described herein may combine the capabilities of a mature Edge Orchestration Engine with a pluggable architecture, and may also leverage the virtualization layer of an IoT Edge Operating System to provide an end-to-end solution for implementing IoT Edge AI across thousands of Edge sites.

The described system may thus provide a unified solution offering a single platform for seamless training, testing, packaging, deploying, monitoring, and updating AI models at the Edge.

In particular, in various embodiments, the described system can offer seamless AI/ML model deployment and/or inference at the Edge, along with end-to-end IoT Edge AI capabilities including model rollouts, updates, inferencing, and monitoring at the Edge.

Further details are provided below.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1 is a block diagram depicting a hardware architecture for implementing the techniques described herein, according to one embodiment.

FIG. 2 is a block diagram depicting a hardware architecture for implementing the techniques described herein in a client/server environment, according to one embodiment.

FIG. 3 is a block diagram depicting, at a high level, the major phases in the lifecycle of an Edge AI application, according to one embodiment.

FIG. 4 is a block diagram depicting some steps that may be involved in the training phase for ML training, according to one embodiment.

FIG. 5A is a block diagram depicting steps that may be involved in ML model packaging as part of the Packaging and Deployment Phase, according to one embodiment.

FIG. 5B is a block diagram depicting steps that may be involved in Edge AI Deployment as part of the Packaging and Deployment Phase, according to one embodiment.

FIG. 6 is a block diagram depicting a Unified, End-to-End IoT Edge AI Framework according to one embodiment.

FIG. 7 depicts a framework, wherein the container orchestration framework of the framework of FIG. 6 has been repurposed to provide AI observability, according to one embodiment.

### DETAILED DESCRIPTION OF THE EMBODIMENTS

The techniques described herein provide a framework and/or method Edge AI model lifecycle management. The system and method provided herein may provide a unified framework that yields an end-to-end solution for implementing IoT Edge AI across thousands of Edge sites by carrying out functions such as training, testing, packaging, deploying, monitoring and updating AI models at the Edge.

### System Architecture

According to various embodiments, the systems and methods described herein can be implemented on any electronic device or set of interconnected electronic devices, each equipped to receive, store, and present information. Each electronic device may be, for example, a server, desktop computer, laptop computer, smartphone, tablet computer, a router, a switch, and/or the like. As described herein, some devices used in connection with the systems and methods described herein are designated as client devices, which are generally operated by end users. Other devices are designated as servers, which generally conduct back-end operations and communicate with client devices (and/or with other servers) via a communications network such as the Internet. In at least one embodiment, the techniques described herein can be implemented in a cloud computing environment using techniques that are known to those of skill in the art.

In addition, one skilled in the art will recognize that the techniques described herein can be implemented in other contexts, and indeed in any suitable device, set of devices, or system capable of interfacing with existing enterprise data storage systems. Accordingly, the following description is intended to illustrate various embodiments by way of example, rather than to limit scope.

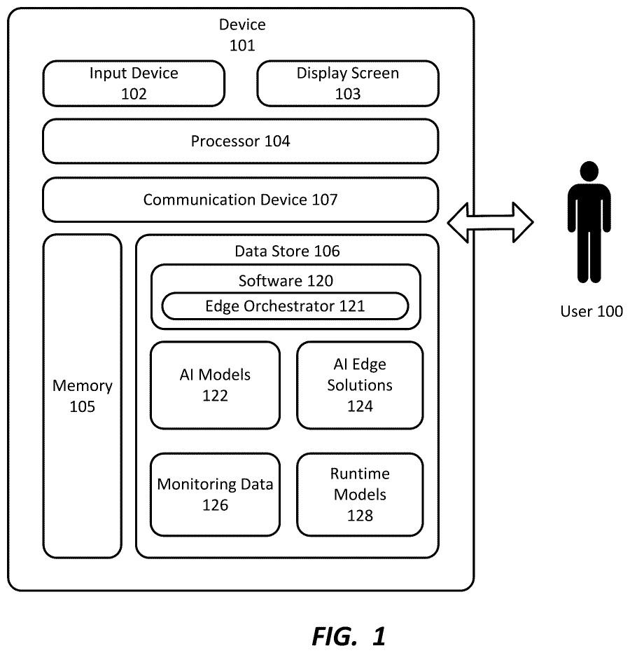

Referring now to FIG. 1, there is shown a block diagram depicting a hardware architecture for practicing the described system, according to one embodiment. Such an architecture can be used, for example, for implementing the techniques of the system in a computer or other device 101. Device 101 may be any electronic device, and in some embodiments, may be an Edge Computing Device or “Edge Node” at the Distributed Edge of a network.

In at least one embodiment, device 101 includes a number of hardware components that are well known to those skilled in the art. Input device 102 can be any element that receives input from user 100, including, for example, a keyboard, mouse, stylus, touch-sensitive screen (touchscreen), touchpad, trackball, accelerometer, microphone, or the like. Input can be provided via any suitable mode, including for example, one or more of: pointing, tapping, typing, dragging, and/or speech. In at least one embodiment, input device 102 can be omitted or functionally combined with one or more other components.

Data store 106 can be any magnetic, optical, or electronic storage device for data in digital form; examples include flash memory, magnetic hard drive, CD-ROM, DVD-ROM, or the like. In at least one embodiment, data store 106 stores information that can be utilized and/or displayed according to the techniques described below. Data store 106 may be implemented in a database or using any other suitable arrangement. In another embodiment, data store 106 can be stored elsewhere, and data from data store 106 can be retrieved by device 101 when needed for processing and/or presentation to user 100. Data store 106 may store one or more data sets, which may be used for a variety of purposes and may include a wide variety of files, metadata, and/or other data.

In at least one embodiment, data store 106 may store datasets such as software 120, which may include firmware, BIOS, a boot loader, an operating system, Edge Orchestrator 121, and/or the like. Data store 106 may further include data such as AI models 122, AI Edge Solution 124, monitoring data 126, and runtime models 128. In at least one embodiment, such data can be stored at another location, remote from device 101, and device 101 can access such data over a network, via any suitable communications protocol.

In at least one embodiment, data store 106 may be organized in a file system, using well known storage architectures and data structures, such as relational databases. Examples include Oracle, MySQL, and PostgreSQL. Appropriate indexing can be provided to associate data elements in data store 106 with each other. In at least one embodiment, data store 106 may be implemented using cloud-based storage architectures such as NetApp (available from NetApp, Inc. of Sunnyvale, California) and/or Amazon Simple Storage Service (Amazon S3) (available from Amazon.com of Seattle, Washington).

Data store 106 can be local or remote with respect to the other components of device 101. In at least one embodiment, device 101 is configured to retrieve data from a remote data storage device when needed. Such communication between device 101 and other components can take place wirelessly, by Ethernet connection, via a computing network such as the Internet, via a cellular network, or by any other appropriate communication systems.

In at least one embodiment, data store 106 is detachable in the form of a CD-ROM, DVD, flash drive, USB hard drive, or the like. Information can be entered from a source outside of device 101 into data store 106 that is detachable, and later displayed after data store 106 is connected to device 101. In another embodiment, data store 106 is fixed within device 101.

In at least one embodiment, data store 106 may be organized into one or more well-ordered data sets, with one or more data entries in each set. Data store 106, however, can have any suitable structure. Accordingly, the particular organization of data store 106 need not resemble the form in which information from data store 106 is displayed to user 100 on display screen 103. In at least one embodiment, an identifying label is also stored along with each data entry, to be displayed along with each data entry.

Display screen 103 can be any element that displays information such as text and/or graphical elements. In particular, display screen 103 may present a user interface for entering, viewing, configuring, selecting, editing, downloading, and/or otherwise interacting with datasets as described herein. In at least one embodiment where only some of the desired output is presented at a time, a dynamic control, such as a scrolling mechanism, may be available via input device 102 to change which information is currently displayed, and/or to alter the manner in which the information is displayed. In at least one embodiment, display screen 103 can be omitted or functionally combined with one or more other components.

Processor 104 can be a conventional microprocessor for performing operations on data under the direction of software, according to well-known techniques. Memory 105 can be random-access memory, having a structure and architecture as are known in the art, for use by processor 104 in the course of running software.

Communication device 107 may communicate with other computing devices through the use of any known wired and/or wireless protocol(s). For example, communication device 107 may be a network interface card (“NIC”) capable of Ethernet communications and/or a wireless networking card capable of communicating wirelessly over any of the 802.11 standards. Communication device 107 may be capable of transmitting and/or receiving signals to transfer data and/or initiate various processes within and/or outside device 101.

In some embodiments, device 101 may be an Edge Computing Device acting as part of a Distributed Edge network. Device 101 may be constantly connected to other devices in the network, or may be only intermittently connected, or even continuously disconnected (“air-gapped”).

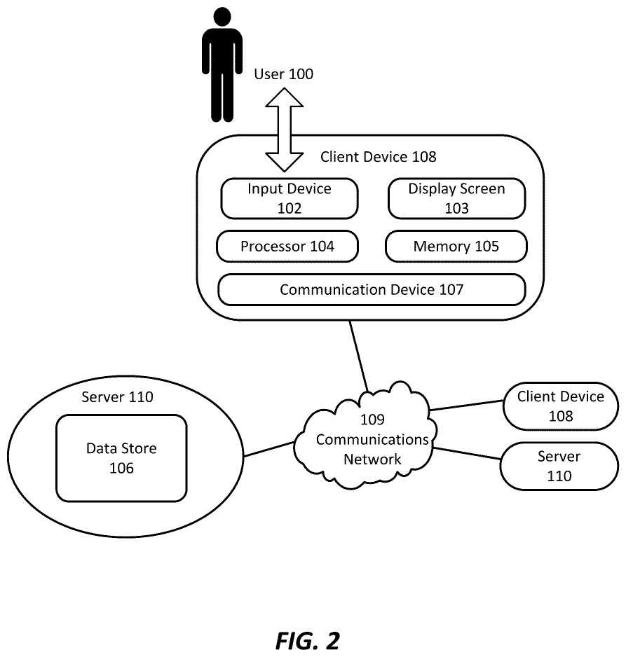

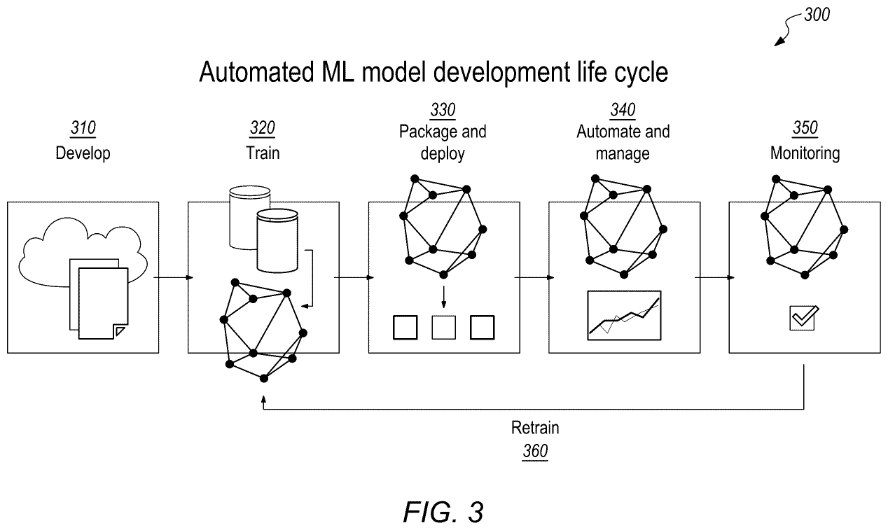

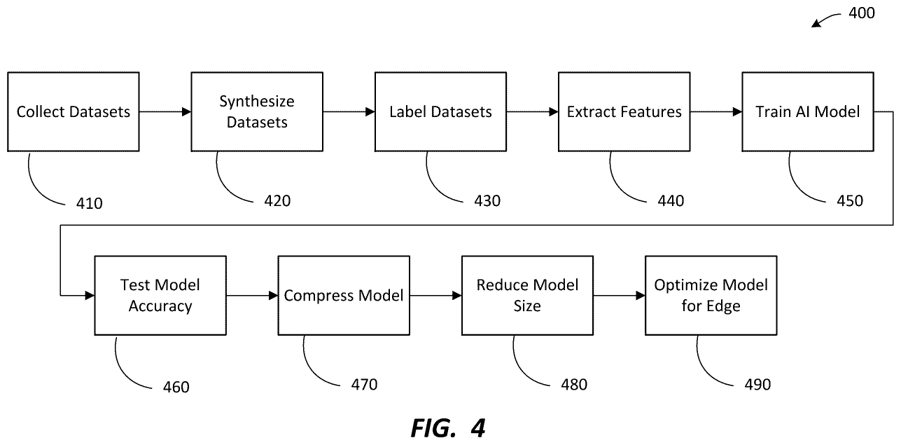

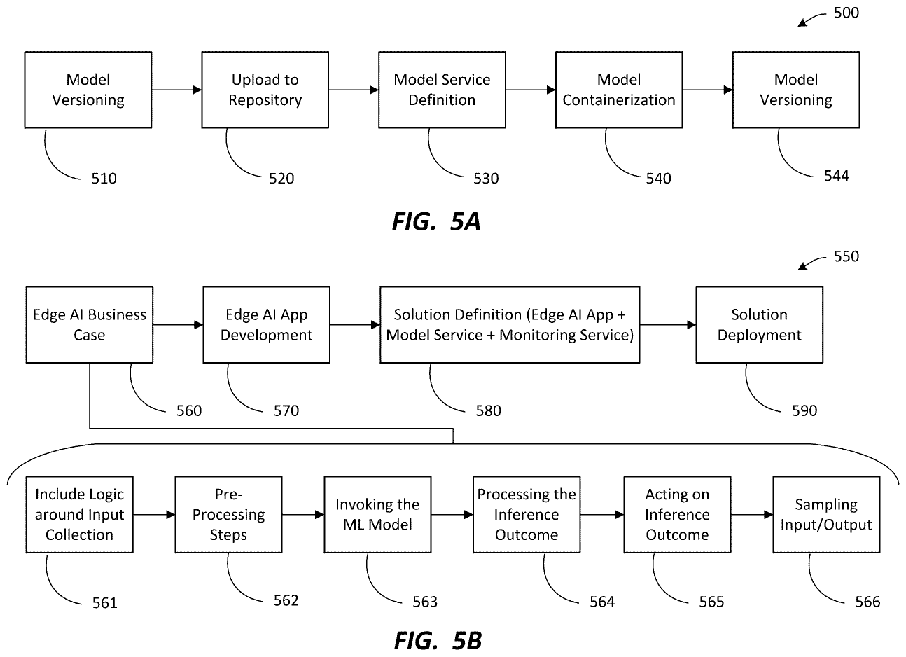

Referring now to FIG. 2, there is shown a block diagram depicting a hardware architecture in a client/server environment, according to one embodiment. Such an implementation may use a “black box” approach, whereby data storage and processing are done completely independently from user input/output. An example of such a client/server environment is a web-based implementation, wherein client device 108 runs a browser that provides a user interface for interacting with web pages and/or other web-based resources from server 110. Items from data store 106 can be presented as part of such web pages and/or other web-based resources, using known protocols and languages such as Hypertext Markup Language (HTML), Java, JavaScript, and the like.

Client device 108 can be any electronic device incorporating input device 102 and/or display screen 103, such as a desktop computer, laptop computer, personal digital assistant (PDA), cellular telephone, smartphone, music player, handheld computer, tablet computer, kiosk, game system, wearable device, or the like. Any suitable type of communications network 109, such as the Internet, can be used as the mechanism for transmitting data between client device 108 and server 110, according to any suitable protocols and techniques. In addition to the Internet, other examples include cellular telephone networks, EDGE, 3G, 4G, 5G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 transmits requests for data via communications network 109, and receives responses from server 110 containing the requested data. Such requests may be sent via HTTP as remote procedure calls or the like.

In some embodiments, client device 108 may be an Edge Computing Device acting as part of a Distributed Edge network. Like device 101, client device 108 may be constantly connected to other devices in the network, or may be only intermittently connected, or even air-gapped.

In one implementation, server 110 is responsible for data storage and processing, and incorporates data store 106. Server 110 may include additional components as needed for retrieving data from data store 106 in response to requests from client device 108.

As described above in connection with FIG. 1, data store 106 may be organized into one or more well-ordered data sets, with one or more data entries in each set. Data store 106, however, can have any suitable structure, and may store data according to any organization system known in the information storage arts, such as databases and other suitable data storage structures. As in FIG. 1, data store 106 may store datasets, including but not limited to software 120, AI models 122, AI Edge Solution 124, monitoring data 126, and runtime models 128, and/or the like; alternatively, such data can be stored elsewhere (such as at another server) and retrieved as needed.

In addition to or in the alternative to the foregoing, data may also be stored in data store 106 that is part of client device 108. In some embodiments, such data may include elements distributed between server 110 and client device 108 and/or other computing devices in order to facilitate secure and/or effective communication between these computing devices.

As discussed above in connection with FIG. 1, display screen 103 can be any element that displays information such as text and/or graphical elements. Various user interface elements, dynamic controls, and/or the like may be used in connection with display screen 103.

As discussed above in connection with FIG. 1, processor 104 can be a conventional microprocessor for use in an electronic device to perform operations on data under the direction of software, according to well-known techniques. Memory 105 can be random-access memory, having a structure and architecture as are known in the art, for use by processor 104 in the course of running software. Communication device 107 may communicate with other computing devices through the use of any known wired and/or wireless protocol(s), as discussed above in connection with FIG. 1.

In one embodiment, some or all of the system can be implemented as software written in any suitable computer programming language, whether in a standalone or client/server architecture. Alternatively, some or all of the system may be implemented and/or embedded in hardware.

Notably, multiple client devices 108 and/or multiple servers 110 may be networked together, and each may have a structure similar to those of client device 108 and server 110 that are illustrated in FIG. 2. The data structures and/or computing instructions used in the performance of methods described herein may be distributed among any number of client devices 108 and/or servers 110. As used herein, “system” may refer to any of the components, or any collection of components, from FIGS. 1 and/or 2, and may include additional components not specifically described in connection with FIGS. 1 and 2. As indicated above, device 101 and/or client device 108 may be intermittently and/or continuously air-gapped from other network devices. As such, communication between device 101 and/or client device 108 and other network resources may, when necessary, be via manual measures, such as connection of a portable storage device such as a USB drive.

In some embodiments, data within data store 106 may be distributed among multiple physical servers. Thus, data store 106 may represent one or more physical storage locations, which may communicate with each other via the communications network and/or one or more other networks (not shown). In addition, server 110 as depicted in FIG. 2 may represent one or more physical servers, which may communicate with each other via communications network 109 and/or one or more other networks (not shown). Part of data store 106 may reside on device 101 and/or client device 108, which may be air-gapped from other network resources as described previously.

In one embodiment, some or all components of the system can be implemented in software written in any suitable computer programming language, whether in a standalone or client/server architecture. Alternatively, some or all components may be implemented and/or embedded in hardware.

### Unified, End-to-End IoT Edge AI Framework

For illustrative purposes, the system and method are described herein in the context of deployment and management of Edge AI. One skilled in the art will recognize, however, that similar techniques can be used in other contexts as well.

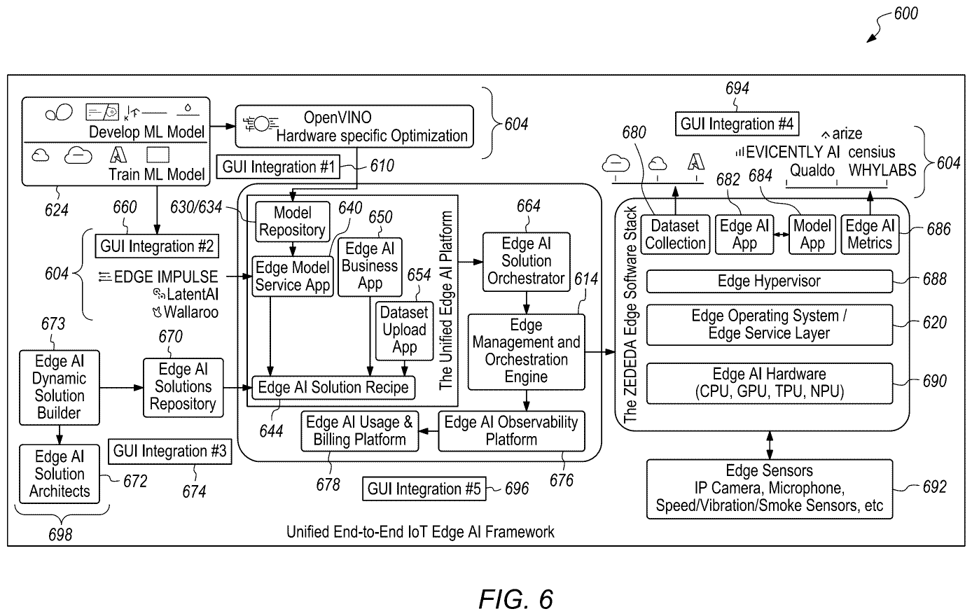

Referring now to FIG. 6, there is shown a block diagram depicting a Unified, End-to-End IoT Edge AI Framework, or framework 600, according to one embodiment. The framework 600 brings together several independent technologies under a single platform with the advantage of managing them “through a single pane of glass.” These may include any or all of the following:
A Unified UI portal for developing and deploying IoT Edge AI solutions by combining a plurality of third party solution providers (these are shown at GUI Integration #1 610, but may incorporate all GUI integrations), which may enable Bring Your Own Model (BYOM) functionality;
An Edge Management and Orchestration Engine 614 for remote management of workloads on Edge devices, tracking and/or passing information such as a inferences, usage hours, and data processed;
An IoT Edge Operating System 620 with advanced virtualization capabilities such as Graphics Processing Unit (GPU) assignment (including partial and/or fractional GPU assignments), CPU pinning, and the ability to run heterogeneous workloads together (such as Virtual Machines, Containers, WebAssembly modules (WASMs), and Kubernetes services);
A pluggable architecture 624 for integrating third party vendors of users'choice for the various stages in IoT Edge AI development;
A Model Repository 630 to host AI models with versioning control;
A repository 634 to host a variety of model Runtimes, such as the ONNX runtime;
A Model optimization framework (included in Edge Model Service App 640) that is pluggable based on a variety of GPU architectures;
A repository (included in Edge AI Solution Recipe 644) to upload and/or consume virtualized IoT Edge AI Model Service Apps, with versioning support;
A repository (included in Edge AI Business App 650) to upload and/or consume virtualized IoT Edge AI Business Apps, with versioning support;
A repository (included in Dataset Upload App 654) to upload and/or consume virtualized Dataset Collection Service Apps, with versioning support;
A method to compose model, Data Collection and Business Apps as a single unit of deployment, in the form of IoT Edge AI Solution Recipes, including combining Virtual Machines, standalone Containers, Kubernetes Resources, Custom Resource Definitions, WebAssembly modules (WASMs), Networks, and/or other Custom Resources using a single, unified packaging format such as an (Yet Another Markup Language) YAML file. This may train and package ML services from 3^{rd} party Edge ML IDE (shown as GUI Integration #2 660). In case of Edge devices grouped together in the form of Kubernetes Clusters, this unified packaging format can be a Helm chart, a Kustomize file, a Canonical Juju file, and/or the like;
An Edge AI Solution Orchestrator 664 that understands the unified packaging format and deploys the IoT Edge AI solution bundle using the Edge Orchestration Engine APIs;
An Edge AI Solutions Repository 670 of curated End-End IoT Edge AI Solution Recipes. These are like blueprints or templates, with a laid out structure of an Edge AI solution, but with variables or placeholders. During deployment, the values for these variables are passed based on the type of Edge device, application, repository URL, etc.;
An On-the-Fly Solution Builder Wizard (included in GUI Integration #3 674) to build and upload new IoT Edge AI solution Recipes. In some embodiments, the On-the-Fly Solution Builder Wizard 674 will implement features where recipes will be automatically generated with minimal input from the user, using Artificial Intelligence based User Agents, using advanced AI techniques such as Agentic AI and Model Context Protocol.
Edge AI Solution Architects 672;
An Edge AI Solution Builder 673 that provides AI Solutions to Edge AI Solutions Repository 670;
An Edge AI Observability Platform 676;
An Edge AI Usage and Billing Platform 678;
A Dataset Collection 680;
An Edge AI App 682;
A Model App 684;
Edge AI Metrics 686;
An Edge Hypervisor 688;
Edge AI Hardware 690;
Edge Sensors 692;
GUI Integration #4 694; and
GUI Integration #5 696.

Repository 634 may host a variety of model Runtimes, including for example “common model runtime” workloads that may be packaged as a container and/or virtual machine, but can be deployed as individual application binaries and/or WebAssembly WASM modules as well. NVIDIA Triton Inference Server, ONNX runtime, and Scailable are examples of such common model runtimes. With model runtimes, the model may be uploaded as a volume for the runtime, and read at the time of running the runtime. The model runtime may expose a standard interface for inference requests from clients, through standardized protocols such as OpenAPI. This provides the flexibility to change models or model versions without having to reload the application. The proposed unified Edge AI framework may support a Marketplace where a collection of such runtimes is available to be deployed on one or many Edge devices, and may allow upload/upgrade of model files to these runtimes at scale across many devices, from a central management plane.

Regarding the model optimization framework, the framework 600 may provide support for starting from any of the following stages in the Edge AI lifecycle:
Model development using popular frameworks (PyTorch, TensorFlow etc). The entire lifecycle may be done using the proposed platform.
Bring your own Model (pre-trained and pre-optimized, but not containerized). The Edge AI framework may take over from this point and may containerize the given model and stage it in the Marketplace for deployment.
Bring your own Model (pre-trained but not optimized yet). The Edge AI framework may provide options for selecting the quantization/pruning parameters and for choosing the target Edge hardware type. The backend may then integrate the right toolset. For example, for an NVIDIA platform, the backend may select TensorRT toolkit, if it is an Intel GPU, it will select OpenVino. This is an example; there could be many such vendors supported and many such toolkits used in the backed.
Bring your own Model (pre-trained, pre-optimized) for deploying with Model runtimes. In this case, Edge AI framework may provide options for choosing the desired Edge AI runtime, and will deploy the model runtime and model together as a unit.
Bring your own Observability provider. In this case, the Edge AI framework may provide options for the observability container to be deployed along with the Edge AI model servers, as a single unit of deployment, along with the startup configuration required for the observability container to send the model telemetry to remote endpoint.
Observability as a service. The proposed framework may also provide a pre-validated list of Edge AI observability providers and startup configurations for each of the providers, which can be passed to the Observability agent deployed on the Edge devices, along with the model server.

### Unified UI Portal for IoT Edge AI Development and Deployment

As shown in FIG. 6, the framework 600 may include various GUI touchpoints, such as GUI Integration #1 610, GUI Integration #2 660, GUI Integration #3 674, GU Integration #4 694, and GUI Integration #5 696.

In at least one embodiment, the Unified IoT Edge AI Framework implements a single unified User Experience by implementing an aggregated User Interface (UI). In at least one embodiment, this is implemented by combining APIs from various partners providing their respective solutions. FIG. 6 shows touchpoints for such integrations at the UI level. In at least one embodiment, five touchpoints are provided, although one skilled in the art will recognize that the depicted embodiment is merely exemplary, and that more or fewer touchpoints may be accommodated.

In at least one embodiment, for training, retraining, and testing of IoT Edge AI models, the aggregated user interface may provide a Jupyter Notebook, which data scientists can use to import their base models, use the ML framework of their choice, train their models, and test and correct them. Once the model is ready for deployment, APIs given by an IoT Edge AI solution provider may be used to upload the trained model to an IoT Edge AI Model Registry, or Model Repository 630. This process is depicted in FIG. 6 as GUI Integration #1 610.

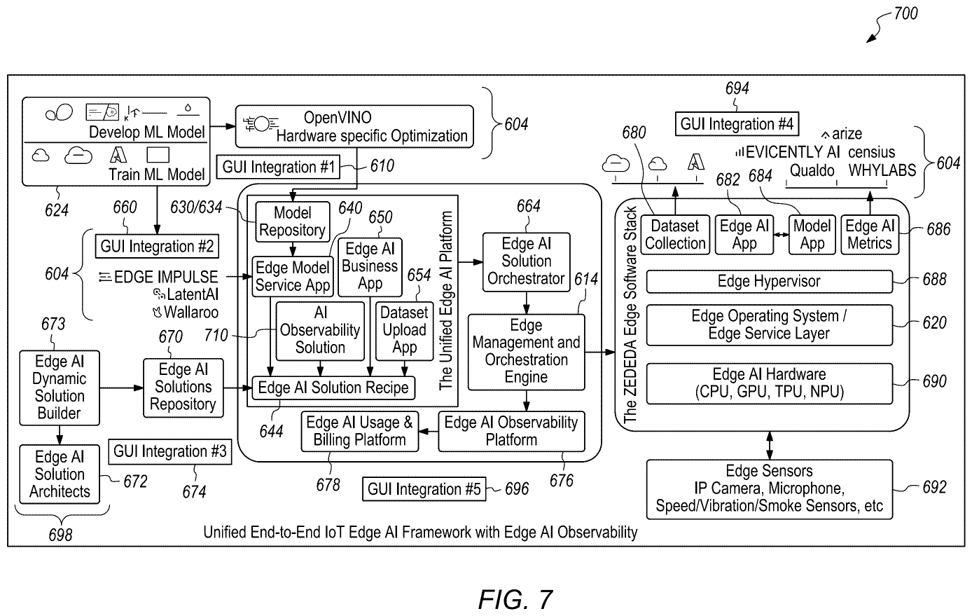

After training an ML/AI model, and before deploying them on Edge devices, the model may be optimized for Edge deployments by techniques such as compression and quantization, so that the model can work in such low-resource environments. This may be useful in situations where Edge devices may not be as powerful as servers in the data centers in terms of memory, CPU, and/or available storage. Any of a number of known solutions may be used for such a step. In at least one embodiment, the framework 600 may provide options for users to choose a solution provider and to seamlessly navigate to such third-party providers through deep URL redirection, by using techniques such as Single-Sign-On and/or Federated OAuth. Through suitable rebranding/white labeling, the framework 600 may offer a consistent look and feel during such navigation. This process is depicted in FIG. 7 as GUI Integration #2 660.

In at least one embodiment, a Marketplace specific to IoT Edge AI Solutions may be offered by the Unified IoT Edge AI framework, which may address any or all of the following individuals (as depicted in FIG. 7 as GUI Integration #3 674):
AI Solution Developers such as System Integrators, who may build IoT Edge AI solutions for a particular Vertical/Use case, and who package their solution in the format specified by the Unified IoT Edge AI Framework, may publish their solution in the Marketplace, with a suitable pricing/licensing scheme for monetizing their solution through the Unified IoT Edge AI framework.
Customers, who may use the Unified IoT Edge AI framework for their business use case at their Edge sites, may choose from available IoT Edge AI solutions. They may search by Industry Verticals (such as Oil and Gas), use cases (such as PPE detection), and/or model types (such as Computer Vision). A selected AI Solution may then be deployed across a plurality of Edge sites using the Edge AI Solution Orchestrator 664 and/or the Edge Management and Orchestration Engines 614.

In at least one embodiment, the system may enable use cases wherein IoT Edge AI Applications running on Edge devices may send their telemetry data about the deployment, such as CPU consumption or any custom metrics according to their application-level expectation. The telemetry data may be sent, for example, to an AI Observability Solution 710. In at least one embodiment, the framework 600 described herein may offer a unified User Interface to navigate to these observability providers and analyze the data. This process is depicted in FIG. 7 as GUI Integration #4 694.

In at least one embodiment, the IoT Edge Operating System 620, through its Hardware Management Layer and Virtualization layer, may collect and upload telemetry data about usage of hardware and software resources. Examples include: hours of usage of GPU, power consumption metrics, hours of usage of the IoT Edge AI Solution, and/or the like. These metrics may be collected and presented on a dedicated page in the framework 600, searchable by tenants and Edge sites. This process is depicted in FIG. 7 as GUI Integration #5 696.

### Pluggable Architecture for Integrating Third Party AI Solution Providers

As shown in FIG. 6, the framework 600 may also include pluggable points 604 for partner integrations, according to one embodiment.

In at least one embodiment, the framework 600 described herein may offer a pluggable architecture for integrating third party service providers at the User Interface layer or at the API layer.

By providing a pluggable architecture, the framework 600 may simplify implementation and may provide extensible capabilities for a rich IoT Edge AI ecosystem.

In at least one embodiment, for integrations during the training/optimization phase, the framework 600 may implement the following scheme:
Onboard of the customer in both the IoT Edge AI framework provider's user directory as well as the third party service provider's user directory.
Map the role of the user between the IoT Edge AI framework provider and the third party provider.
Set up a common authentication provider through techniques such as federated authentication using protocols such as Open ID Connect and OAuth. By having a common authentication provider, the Unified IoT Edge AI framework may provide a Single-Sign-On User experience, and may enable users to seamlessly navigate between the framework's own UI and the partner UI, without any re-login requirements.
Along with implementation of Deep URL redirections from the partner UI and framework UI, and partner UI customization, the framework may provide a consistent view of the UI and a unified user experience.
In at least one embodiment, for integrations related to IoT Edge AI Solution deployments, such as connecting the deployed IoT Edge AI workloads to their Cloud counterparts for use cases like IoT Edge AI monitoring and Cloud-based training/sampling, the framework may implement the following scheme:
The user may configure a set of pre-defined partners and their API credentials in a separate “partner configuration management” section of the framework 600.
At the time of deploying a chosen IoT Edge AI solution for rollout to Edge Sites, the user may be presented with options to choose a partner of choice.
The framework 600 may take the partner configuration from the back-end, and may invoke a suitable set of APIs to provision the resources corresponding to the new site of deployment, such as by creating a digital twin of the deployment, configuring a unique ID for this deployment, and/or the like.
The framework 600 may populate the connection URL for the partner, API credentials to talk to the partner, and/or any unique ID given by the partner in the IoT Edge AI solution deployment definition. This step may be performed as part of a cloud-init for Virtual Machines and/or any volume mounted into the container in case of OCI containers. Such implementations are merely exemplary; in other embodiments, any such scheme may be implemented based on the workload type at the Edge site and the capabilities of the Edge Virtualization Engine.

### Edge Orchestration Engine for Remote Device Management

As shown in FIG. 6, the framework 600 may include the Edge Management and Orchestration Engine 614.

In at least one embodiment, the Edge Management and Orchestration Engine 614 may be implemented as a software component of the framework 600, and may be responsible for any or all of the following:
Remotely managing the lifecycle of the IoT Edge Operating System 620 on Edge devices spread across geographically diverse locations, from a centralized location;
Deploying virtualized IoT Edge AI workloads on Edge devices, including but not limited to Virtual Machines, Containers, Kubernetes Clusters, workloads on Kubernetes Clusters, Unikernels, WebAssembly modules (WASMs), and/or the like; and
Providing a comprehensive data store to upload binary packages of virtualized workloads and IoT Edge Operating System images/patches.

### IoT Edge AI Solution Orchestration Engine

As shown in FIG. 6, the framework 600 may include the Edge AI Solution Orchestrator 664.

In at least one embodiment, the Edge AI Solution Orchestrator 664 may be implemented as a component of the framework 600. Given an IoT Edge AI Solution Recipe and an Edge device, the Edge AI Solution Orchestrator 664 may perform any or all of the following steps:
Develop a Directed Acyclic Graph (DAG) of dependencies among the components in the given Solution;
Deploy different components defined inside the Recipe on the Edge device following an order in the DAG;
Use the Edge Orchestration Engine to create digital twins for the individual components on the Edge device and eventual deployment of the components on the Edge device;
Provide policies to match a plurality of Edge devices for mass deployments across sites;
Provide flexibility to work with one or more Edge Orchestration Engine(s), based on the type of Edge Operating System and the Edge Virtualization Engine type; and
Provide a mechanism to make modifications to the applied policies, drive upgrades across the Edge devices, and/or present the status of the upgrades.

### IoT Edge Operating System and Edge Virtualization Engine

As shown in FIG. 6, the framework 600 may include the IoT Edge Operating System 620 and Edge Virtualization Layer.

In at least one embodiment, the IoT Edge Operating System 620, along with its Edge Virtualization Layer, may provide any or all of the following features to implement the overall functionality of the framework 600:
Maintaining secure network connectivity to the Edge Management and Orchestration Engine 614, with cryptographic identity rooted at the hardware, using hardware security modules (HSM);
Polling the Edge Management and Orchestration Engine 614 for any configuration updates;
Applying the configuration updates;
Hosting heterogeneous virtualized workloads on the Edge device, such as for example, Virtual Machines, Containers, WebAssembly modules (WASMs), Unikernels, and/or Kubernetes workloads;
Providing network connectivity to Edge Workloads;
Connecting hardware components such as a Graphics Processing Unit (GPU) to virtualized workloads such as Virtual Machines, Containers, and/or WebAssembly modules (WASMs);
Implementing Access Control Lists (ACLs) for allowing/disallowing network connections between the Edge workloads and external networks;
Providing telemetry support for publishing resource usages, performance metrics, logs, and/or traces of both host software and virtualized workloads; and
Running workloads without interruptions, even when there is no connectivity to the Edge Orchestration Engine.

### IoT Edge AI Model Repository

As shown in FIG. 6, the framework 600 may include the Model Repository 630, according to one embodiment.

The Model Repository 630 may be used to keep track of experiments and different versions of a trained model, along with the datasets used to train/test those models. The Model Repository 630 may help in tracking different versions of the model, and may enable team members to use the same version and dataset for reproducible experiments.

In at least one embodiment, the Model Repository 630 may be used in connection with the framework 600. While the user can bring their models from their own model registries and still work with the framework 600 using GUI Integration #1 as described above, the framework 600 may also host a dedicated Model Repository 630, including any or all of the following features:
A Central Repository to upload IoT Edge AI models;
Role-Based Access Control for restricting Read/Write/Update access to models;
Versioning support for models;
Support for any or all model frameworks, including but not limited to TensorFlow, TFLite, PyTorch, XGBoost, SciKitLearn, and/or the like;
Support for the Open Neural Network Exchange (ONNX) format;
Ability to tag the models with labels such as production, testing, alpha, and/or the like;
Ability to point to datasets used for training the model. Datasets may be stored in any cloud storage, including but not limited to S3, Blob, and/or the like. In some embodiments, the framework 600 may integrate with third party providers such as KubeFlow Feast or Databricks to provide a store of online and/or offline feature as a service for streaming and/or batch-inference workloads;
Support for describing hardware requirements to run the model;
Support for populating performance benchmark numbers;
Support for specifying pricing/licensing details for using the model; and
A supported workflow to containerize models for staging for Edge deployment, by uploading them into IoT Edge AI Model Service App in data stores used by the Edge Orchestration Engine and the Edge Solution Engine for rolling out as part of the IoT Edge AI solution Recipe, as will be detailed below.

### IoT Edge AI Model Service Apps

As shown in FIG. 6, the framework 600 may include the Edge Model Service App 640.

In at least one embodiment, when a trained ML model is available, the next step is to package it in the form of a runnable (preferably a container) for hosting the model for inference requests from other applications. This process may be referred to as “ML model serving.”

In at least one embodiment, the IoT Edge AI Provider may host a repository of IoT Edge AI Model Service Apps. The repository may provide versioning and dependency tracking support for IoT Edge AI Model Service App.

Since the Edge AI Solution Orchestrator 664 uses containers as the package model for the workloads at the Edge, in at least one embodiment, the framework 600 uses containerization techniques for ML serving. Any suitable automatic containerization tool may be used, such as Bento.ml, Chassis.ml, and/or the like.

The containerization tool may take the service file of the ML model and package the model as a container with gRPC or REST APIs exposed for inference requests from other applications. Once the ML model is containerized using the service file, the container can then be deployed on top of IoT Edge AI Provider's Virtualization layer at the Edge, after exposing GPUs and other Inference accelerators to the container.

In at least one embodiment, separation of ML Models from the application logic around the ML model may provide flexibility to upgrade ML models on the field without having to upgrade the application logic.

Some Edge ML studios (such as Edge Impulse or Latent AI) may provide support for ML model packaging by providing a docker image as the final artifact with a definition of the REST API payload. In such cases, models may be directly uploaded to the ML Model Service Apps repository, bypassing the packaging stage.

### IoT Edge AI Business App

As shown in FIG. 6, the framework 600 may include the Edge AI Business App 650.

In at least one embodiment, IoT Edge AI Apps may be written by ML Engineers for a specific IoT Edge AI inference use case, driven by a particular business need at the Edge. For example, an app may be written for an image classification use case, including automatic trigger of alerts by email or via SMS messaging, based on certain classification outcomes.

To address this requirement, the IoT Edge AI Provider may host a repository of IoT Edge AI Business Apps. In at least one embodiment, the repository may host both Development Apps (PoC) as well as apps supported by the IoT Edge AI Provider, under commercial license.

In at least one embodiment, the Edge AI Business App 650 may communicate with Edge Model Service App 640 over gRPC, REST API, or the like. In at least one embodiment, Edge AI Business App 650 may be packaged as OCI containers for ease of distribution or ease of consumption by more advanced workload orchestrators such as K3S, K8S, and/or the like.

For example, each AI app container may package any or all of the following:
A program that runs the IoT Edge AI app (e.g. object detection.py);
The runtime required to run the program (python packages, C++ libraries, and/or the like) (can be written in any language, such as for example, Python, R, Golang, Rust, Java, C++, and/or the like);
Client code to talk to the ML Service App for inference; and
Pre-processing and post-processing stages in the ML pipeline.
In at least one embodiment, a description under each IoT Edge AI app may provide any or all of the following information:
A supported platforms list for this IoT Edge AI App (such as, for example, x86/ARM, Intel/NVIDIA/Qualcomm, AMD, and/or the like);
A Service API expected from the AI Model Service App;
Parameters/ENV variables and/or explanations;
A Docker Command line to launch the app; and
An API definition and version supported by the Business App for the ML service App.

### Dataset Collection Service App

As shown in FIG. 6, the framework 600 may include a Dataset Upload App 654, which may include a Data Collection Service App.

In many IoT Edge AI solutions, one of the initial steps is to collect datasets from the sensors. It is important to have quality datasets in order to arrive at good ML model performance. It is also important to gather datasets from a variety of Edge locations, in order to reflect real-world distribution of the datasets. Datasets are also often used in feature engineering, to arrive at the right set of features for the ML model.

Even though it is an initial step before training, dataset sampling is often implemented as a continuous process throughout the ML deployment lifecycle for continuous training and improvement. Accordingly, in at least one embodiment, the IoT Edge AI Provider may host Dataset Collection as a service as part of the IoT Edge AI platform.

In at least one embodiment, a customer can configure the data lake of their choice as the destination for the datasets, and the service may stream the datasets from all deployed Edge devices in the field.

### IoT Edge AI Solution Recipes

As shown in FIG. 16, the framework 600 may include an Edge AI Solution Recipe 644. The Edge AI Solution Recipe 644 represents the IoT Edge AI Provider's hosted repository of deployable end-to-end IoT Edge AI solutions.

In at least one embodiment, an IoT Edge AI Solution combines various components required to run an IoT Edge AI app at the Edge, such as for example:
One or more IoT Edge AI Model Service Apps;
One or more Edge ML Business Apps;
One or more Data Sampling and/or ML Monitoring Apps;
Other containers that may be required in the solution (such as MQTT adapter, syslog broker, and/or the like);
The network connectivity among the containers (such as namespace, service definitions, and/or the like); and
The runtime configuration for each of the containers.

In at least one embodiment, any or all of the above components may be coupled with the IoT Edge AI Provider Solutions project. Based on the IoT Edge AI Provider's Solutions architecture, the Solution Recipe may be packaged in a format expected by IoT Edge AI Provider's Solutions architecture.

In at least one embodiment, a description under each IoT Edge AI Solution may provide any or all of the following information:
List of IoT Edge AI Apps used;
List of other containers used; and
Platforms supported.

### On-the-Fly IoT Edge AI Solution Builder (Advanced)

As shown in FIG. 6, the framework 600 may include an On-the-fly Edge AI Solution Builder Wizard 698. This Edge AI Solution Builder Wizard 698 may be a step-by-step wizard that can help developers build and/or assemble an IoT Edge AI solution.

In at least one embodiment, the Edge AI Solution Builder Wizard 698 takes the AI developer through a series of simple steps, including for example:
Select the IoT Edge AI use case (such as, for example, Image Processing);
Select the IoT Edge AI Model to deploy in that selected use case (such as, for example, Image segmentation);
Select the hardware configuration (such as, for example, GPU/TPU, ARM/X86);
Select the IoT Edge AI application for the use case (there may be many IoT Edge AI Apps for the use case and platform selected);
Select any pre-processing app if required;
Select any post-processing app if required; and
Select the connectivity options (such as, for example, shared volume, network connections, connection URLs).

After receiving the inputs, the IoT Edge AI Provider back-end may dynamically prepare a complete IoT Edge AI solution and upload it in the IoT Edge AI Solutions page, in the form of a helm chart. The developer can then deploy the IoT Edge AI solution using the IoT Edge AI Provider's zero-touch deployment profiles, to thousands of Edge devices.

In some embodiments, The Edge AI Solution Builder Wizard 698 may provide functionality to automatically generate recipes with minimal input from the user, using Artificial Intelligence based User Agents, for example, via advanced AI techniques such as Agentic AI and Model Context Protocol.

### Curated End-to End Solutions

As shown in FIG. 18, the framework 600 may include the Edge AI Solutions Repository 670, which may host a curated set of IoT Edge AI Solutions, according to one embodiment.

In at least one embodiment, the Unified IoT Edge AI Provider may provide an initial set of curated IoT Edge AI solutions in the Edge AI Solution Repository 670 for various use cases and for various platforms. These solutions may be published in the same Edge AI Solutions Repository 670 with a tag indicating that it is an official distribution. In at least one embodiment, a pay-as-you-go licensing model may be used for these solutions. Any suitable mechanism can be used for metering the usage, including for example:
Number of inferences done;
Number of hours the IoT Edge AI solution was used; and/or
Amount of data processed by the IoT Edge AI solution (for example, in case of Generative AI, this may be the number of tokens processed and generated).

In at least one embodiment, a user view of this list might include the following:
Image Segmentation Solution for Retail Billing, Input: file, output: file, Optimized for NVIDIA T4 GPU;
Breakdown prediction based on noise samples, Optimized for Intel Neural Stick, Input: file, output: MQTT; and/or
A Voice Assistant in the field served by the Edge device, using Small Language Models, with multi modal inputs such as audio and computer vision, trained with domain-specific information and provided with a Retrieval Augmented Generation, for example, using vectorDB such as FAISS (Facebook AI Similarity Search) or the like.

### Orchestrating Edge AI Observability at Scale

In at least one embodiment, the described system may enable and orchestrate Edge AI observability at scale. AI observability refers to continuous monitoring of deployed AI models for their performance against established baseline values and improving the models based on the observed results. In many situations, monitoring AI models deployed at the Edge may be different from monitoring models deployed in the Cloud, posing some practical challenges. For example:
The number of deployed instances of the given AI model at the Edge may be very high compared to the Cloud. While there may be a single instance of the model deployed for serving in the Cloud, there may be a distinct instance of the model per Edge device or per Edge cluster, which means the number is roughly equal to the number of Edge devices deploying this model.
Provisioning the baseline values or reference dataset for AI monitoring is an important step in AI Observability. Being able to push this reference dataset to all these Edge devices, and being able to push updates to these dataset from a single management platform is very helpful.
Provisioning of agents who monitor the performance of the model and post their metrics to a central monitoring system in the Cloud, from thousands of Edge devices distributed across the globe, in a zero-touch fashion is very helpful for Edge AI Observability.

In at least one embodiment, the described system and method address these issues and provide a scalable solution with a centralized management capability. In order to accomplish these goals, the system may provide:
Edge AI Monitoring App and Observability Platform(s); and/or
Continuous Integration, Continuous Deployment (CI/CD).

### Edge AI Observability

Referring now to FIG. 7, there is shown a block diagram depicting a framework 700, wherein the container orchestration framework of the framework 600 has been repurposed to provide AI observability, according to one embodiment. Using this configuration, the Framework 700 may provide an AI Observability Solution 710 along with a mainstream AI solution.

In at least one embodiment, an observability SDK may be provided as part of an AI Model Service App to export a metrics API. The Metrics Collection App may run along with an ML Model Service App. The app may pull metrics from the AI Model Service App and publish it to any suitable third-party ML Observability platforms such as Arize.com, WhyLabs, and/or the like.

In at least one embodiment, onboarding of the model to the third-party app may be performed by the Metrics Collection App using credentials pushed through Config Envelope constructs available in the Edge AI Provider Solutions platform. The observability platform may also perform periodic sampling of inputs/output features and uploading them to a cloud sink for cloud or federated learning.

In at least one embodiment, the GUI of the third-party ML Monitoring portal may be integrated with the Edge AI GUI, to provide a seamless experience including functionality such as viewing dashboards, setting up monitors, and/or the like.

### Continuous Integration/Continuous Deployment (CI/CD)

In at least one embodiment, the unified Edge AI platform provides full support for CI/CD of the Edge AI deployments. Based on feedback from monitoring ML model performance from the ML monitoring solution, remedial actions may include, for example:
Addressing drift;
Addressing skewed representation of datasets;
Correcting issues related to overfitting or underfitting; and/or
Addressing dataset quality issues.

The ML model may need to be retrained based on feature set modification and/or model topology, using additional datasets uploaded by the observability solution. Once the model is retrained, a new version of the ML model may be uploaded to the ML Model Registry, or Model Repository 630.

In at least one embodiment, a workflow may be configured to automatically retrigger containerization of the new version of the ML model and to upload a corresponding version of the AI Model Service App to the Edge AI Model Service App Repository. Based on the update to the ML service App Repository, a new version of the Edge AI Solution recipe with an updated version of the ML Service app may be created.

In at least one embodiment, based on the update policy of the Solution, the update may be automatically applied to the Edge devices; alternatively, a notification may be transmitted to an admin for approval before the upgrade is rolled out. Once the new solution version is rolled out, the new ML model may take effect. A new cycle of monitoring may then begin for the deployed ML model.

Optimization may be carried out relative to the hardware utilized on the Edge Network. For example, the framework 600 and/or the framework 700 may have a software toolkit for optimizing the operation of an Intel GPU, an NVIDIA GPU, and/or any other hardware processing device.

In some embodiments, the framework 600 and/or the framework 700 may be agnostic as to the specific hardware present in the Edge Network. This may allow the user to bring in a desired optimization. Such software toolkits may be plugged in at the back end, for example, as an intermediate layer. This may allow the user to select the optimization based on the hardware, without concern for which specific hardware is present in the Edge Network.

### Orchestrating Edge AI Models without Storing Them in the Cloud

In at least one embodiment, the framework 600 and/or the framework 700 described herein may be used to enable data scientists to develop AI models from scratch, and then deploy them at scale on Edge devices. These Edge AI models may be stored in Edge AI model repositories. Public AI model repositories such as HuggingFace exist; the Unified Edge AI framework described herein may also provide a hosted model repository to upload trained models. An ML engineer can then deploy one or more of these AI models using the described Unified Edge AI framework, which may pull the model(s) and send them over the network to the Edge devices for deployment.

In some commercial settings, models may be trained using an internal data science team of an organization, and each model may form a core component of a proprietary solution offered by the organization. Thus, the model(s) may be part of the intellectual property of the organization. In such cases, uploading the model(s) to a public model repository or uploading them to a repository managed by the Edge AI framework provider may be problematic, as it may pose the risk of leaking intellectual property.

At the same time, having the capability to store models in a central repository, to version them and refer to them from an Edge AI framework provider, and to deploy them on Edge devices using all the various features of an Edge Orchestrator may be very compelling for an organization looking to orchestrate Edge AI models on thousands of Edge devices from a single management platform.

The Edge UI framework described herein may provide a solution to these two seemingly contradictory requirements. According to various embodiments, Edge AI framework providers need not store Edge AI models in their repositories, but can still orchestrate deployment of these Edge AI models on Edge devices. Further details are provided below.

As shown in FIG. 7, the framework 700 may include the Edge AI Model Repository, or Model Repository 630.

Model repositories may host pre-trained ML models. In at least one embodiment, the Edge AI Provider may manage one or more model repositories, so that: a) users may upload a trained ML model for others to use (development/PoC use); and b) the Edge AI Provider may publish curated models with regular upgrades and with a support guarantee. In at least one embodiment, the system may also provide versioning support.

In at least one embodiment, the system may organize model repositories to include, for example, Optimized and General Purpose categories. Models can be provided either in plain (such as TensorFlow/PyTorch) format or in optimized formats. When optimized, the model information may describe the platform for which it is optimized. In at least one embodiment, the system may provide support for formats such as ONNX to comply with open standards.

In at least one embodiment, on-demand optimization may be supported as a service. In addition, on-demand optimization may optionally be provided, for example by generating optimized models for the requested platform. This may be implemented, for example, via a dedicated pool of Edge AI platforms accessible to the Edge AI Provider. In at least one embodiment, such an arrangement may be provided via a paid service to optimize and validate the Edge AI App using a pool of Edge AI devices before mass rollout.

In at least one embodiment, models may be cataloged per Industry and/or per use-case for easy reference.

In at least one embodiment, an available resource such as neptune.ai or MLFlow may be used as the Model Repository service.

In at least one embodiment, every ML model may also have a service definition, for example in the form of a python script, for ML serving.

### GPU Utilization

In at least one embodiment, the framework 600 and/or the framework 700 may control the use of one or more GPUs on the Edge Network. For example, a powerful GPU may be virtualized, permitting the use of one or more independent logical GPUs and/or fractional GPUs.

More specifically, utilization of such GPUs may be allocated among Edge Computing Devices according to any desired scheme. In certain Edge deployments, it may be useful to logically divide the underlying hardware GPU into one or many virtual GPUs (vGPU), often using the toolkit provided by the GPU vendor. The framework 600 may allow use of a unified GPU allocation mechanism and GPU usage monitoring mechanism that is agnostic to the hardware vendor type, using logical abstractions like number of vGPUs, pods, schedulers etc. This support at the Edge may be referred to as fractional GPU assignment for multi-tenant application workloads at the Edge.

### Repository to Host Model Runtimes

In at least one embodiment, the framework 600 and/or the framework 700 may be designed to support a plurality of runtimes at the Edge. Model runtimes may provide a common environment capable of supporting such a plurality of runtimes. Such runtimes may be contained as volumes.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. In addition, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to convey the substance of their work most effectively to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Washington; MacOS, available from Apple Inc. of Cupertino, California; iOS, available from Apple Inc. of Cupertino, California; Android, available from Google, Inc. of Mountain View, California; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for implementing artificial intelligence (AI) over an IoT Edge Network, the method comprising:
at one or more storage devices, storing an AI model;
at one or more hardware processing devices, using the AI model to develop an AI Edge Solution suitable for achieving a business purpose through the IoT Edge Network; and
at one or more communication devices, deploying the AI Edge Solution to a plurality of Edge Computing Devices within the IoT Edge Network.

2. The method of claim 1, further comprising, at the one or more storage devices, receiving third party data from a third party;
and wherein at least one of storing the AI model and developing the AI Edge Solution comprises using the third party data.

3. The method of claim 2, further comprising:
at an input device, receiving user input; and
at the one or more communication devices, communicating the user input to a third party service hosted by the third party to initiate receipt of the third party data.

4. The method of claim 2, further comprising:
at an input device, receiving user credentials from a user; and
at the one or more communication devices:
transmitting the user credentials to a third party service hosted by the third party; and
receiving confirmation of authentication, by the third party, of the user credentials.

5. The method of claim 1, wherein:
developing the Edge AI Solution comprises receiving an AI Solution Recipe;
the method further comprises, at the one or more hardware processing devices, developing a Directed Acyclic Graph (DAG) of dependencies among components in the AI solution; and
deploying the Edge AI solution comprises deploying components of the AI Solution Recipe according to an order in the DAG.

6. The method of claim 1, further comprising, at the one or more hardware processing devices, packaging the AI model to generate a packaged AI model;
and wherein storing the AI model comprises storing the packaged AI model.

7. The method of claim 1, further comprising:
at the one or more communication devices, receiving a dataset from one or more sensors connected to the one or more of the Edge Computing Devices; and
at the one or more hardware processing devices, using the dataset to develop an Improved AI Edge Solution.

8. The method of claim 7, further comprising, at the one or more storage devices, storing the AI Edge Solution and a plurality of additional AI Edge Solutions, each of which is deployable on the IoT Edge Network.

9. The method of claim 1, further comprising:
at a user output device, querying the user via an AI solution builder wizard; and
at an input device, receiving query responses from the user;
and wherein developing the AI Edge Solution comprises using the query responses.

10. The method of claim 1, further comprising
at the one or more storage devices, storing a plurality of Curated AI Edge Solutions; and
at an input device, receiving a user selection of one of the Curated AI Edge Solutions;
and wherein developing the AI Edge Solution comprises using the user selection.

11. The method of claim 1, further comprising, at the one or more communication devices:
receiving monitoring data indicative of performance of the AI Edge Solution; and
publishing the monitoring data to a third party machine learning observability platform.

12. The method of claim 1, further comprising:
at the one or more communication devices, receiving monitoring data indicative of performance of the AI Edge Solution; and
at the one or more hardware processing devices, using the monitoring data to optimize the AI Edge Solution.

13. The method of claim 1, further comprising:
at the one or more hardware processing devices, virtualizing a GPU to generate a virtual GPU; and
at the one or more communication devices, allocating utilization of the virtual GPU across a plurality of the Edge Computing Devices.

14. The method of claim 1, further comprising, at the one or more storage devices, storing a model runtime;
and wherein developing the AI Edge Solution comprises incorporating the model runtime in the AI Edge Solution to permit addition of a plurality of additional AI models to a runtime used by the AI Edge Solution.

15. The method of claim 1, further comprising:
at the one or more storage devices, storing software toolkits for a variety of hardware processor types; and
at the one or more hardware processing devices, optimizing the AI Edge Solution by automatically selecting the software toolkit applicable to the one or more hardware processing devices.

16. The method of claim 1, wherein storing the AI model comprises storing the AI model via a centralized portal configured to:
store a plurality of additional AI models for versioning and lineage; and
store datasets for versioning and lineage;
and wherein developing the AI Edge Solution comprises using the centralized portal to fine tune, compress, and quantize the additional AI models.

17. The method of claim 1, wherein storing the AI model comprises storing the AI model via a centralized portal configured to store a curated list of pre-validated Edge AI Solution blueprints;
and wherein developing the AI Edge Solution comprises:
composing the AI model along with business logic to generate the Edge AI Solution; and
utilizing a no-code or low-code platform to generate customized set of the Edge AI Solution blueprints.

18. The method of claim 1, further comprising, at the one or more hardware processing devices, implementing an observability platform that collects metrics, related to performance of the Edge AI Solution, and computes statistical distributions for input and output features to detect drifts in input and/or performance of the AI model.

19. The method of claim 1, wherein deploying the AI Edge Solution comprises:
pushing blueprints and/or the AI model for the Edge AI Solution to the Edge devices in an automated manner through continuous integration techniques by using a centralized server to populate the blueprints and/or the AI model in a storage server; and
using software agents, deployed at the Edge Computing Devices, to fetch the blueprints and/or the AI model.

20. The method of claim 1, wherein storing the AI model comprises storing the AI model via a centralized portal configured to:
host a marketplace of third party Edge AI models from third parties; and
facilitate deployment of the third party Edge AI models on a selected set of the Edge Computing Devices.

21. The method of claim 1, wherein the AI Edge Solution is agnostic as to the specific hardware present in the Edge Network.

22. A non-transitory computer-readable medium for implementing artificial intelligence (AI) over an IoT Edge Network, comprising instructions stored thereon, that when performed by one or more hardware processing devices, perform the steps of:
causing one or more storage devices to store an AI model;
using the AI model to develop an AI Edge Solution suitable for achieving a business purpose through the IoT Edge Network; and
causing one or more communication devices to deploy the AI Edge Solution to a plurality of Edge Computing Devices within the IoT Edge Network.

23. The non-transitory computer-readable medium of claim 22, further comprising instructions stored thereon, that when performed by one or more hardware processing devices, cause the one or more storage devices to receive third party data from a third party;
and wherein at least one of storing the AI model and developing the AI Edge Solution comprises using the third party data.

24. The non-transitory computer-readable medium of claim 23, further comprising instructions stored thereon, that when performed by one or more hardware processing devices, perform the steps of:
causing an input device to receive user input; and
causing the one or more communication devices to communicate the user input to a third party service hosted by the third party to initiate receipt of the third party data.

25. The non-transitory computer-readable medium of claim 22, further comprising instructions stored thereon, that when performed by one or more hardware processing devices, perform the steps of:
causing the one or more communication devices to receive a dataset from one or more sensors connected to the one or more of the Edge Computing Devices; and
using the dataset to develop an Improved AI Edge Solution.

26. The non-transitory computer-readable medium of claim 25, further comprising instructions stored thereon, that when performed by one or more hardware processing devices, cause the one or more storage devices to store the AI Edge Solution and a plurality of additional AI Edge Solutions, each of which is deployable on the IoT Edge Network.

27. The non-transitory computer-readable medium of claim 22, further comprising instructions stored thereon, that when performed by one or more hardware processing devices, perform the steps of:
causing a user output device to query the user via an AI solution builder wizard; and
causing an input device to receive query responses from the user;
and wherein developing the AI Edge Solution comprises using the query responses.

28. The non-transitory computer-readable medium of claim 22, further comprising instructions stored thereon, that when performed by one or more hardware processing devices, perform the steps of:
causing the one or more storage devices to store a plurality of Curated AI Edge Solutions; and
causing an input device to receive a user selection of one of the Curated AI Edge Solutions;
and wherein developing the AI Edge Solution comprises using the user selection.

29. The non-transitory computer-readable medium of claim 22, further comprising instructions stored thereon, that when performed by one or more hardware processing devices, cause the one or more communication devices to:
receive monitoring data indicative of performance of the AI Edge Solution; and
publish the monitoring data to a third party machine learning observability platform.

30. The non-transitory computer-readable medium of claim 22, further comprising instructions stored thereon, that when performed by one or more hardware processing devices, perform the steps of:
causing the one or more communication devices to receive monitoring data indicative of performance of the AI Edge Solution; and
using the monitoring data to optimize the AI Edge Solution.

31. The non-transitory computer-readable medium of claim 22, further comprising instructions stored thereon, that when performed by one or more hardware processing devices, perform the steps of:
virtualizing a GPU to generate a virtual GPU; and
causing the one or more communication devices to allocate utilization of the virtual GPU across a plurality of the Edge Computing Devices.

32. A system for implementing artificial intelligence (AI) over an IoT Edge Network, the system comprising:
one or more storage devices configured to store an AI model;
one or more hardware processing devices configured to use the AI model to develop an AI Edge Solution suitable for achieving a business purpose through the IoT Edge Network; and
one or more communication devices configured to deploy the AI Edge Solution to a plurality of Edge Computing Devices within the IoT Edge Network.

33. The system of claim 32, wherein the one or more storage devices are further configured to receive third party data from a third party;
and wherein the one or more storage devices are configured to store the AI model using the third party data and/or the one or more hardware processing devices are configured to develop the AI Edge Solution comprises using the third party data.

34. The system of claim 33, further comprising:
an input device configured to receive user input;
and wherein the one or more communication devices are further configured to communicate the user input to a third party service hosted by the third party to initiate receipt of the third party data.

35. The system of claim 32, wherein:
the one or more communication devices are further configured to receive a dataset from one or more sensors connected to the one or more of the Edge Computing Devices; and
the one or more hardware processing devices are configured to use the dataset to develop an Improved AI Edge Solution.

36. The system of claim 35, wherein the one or more storage devices are further configured to store the AI Edge Solution and a plurality of additional AI Edge Solutions, each of which is deployable on the IoT Edge Network.

37. The system of claim 32, further comprising:
a user output device configured to query the user via an AI solution builder wizard; and
an input device configured to receive query responses from the user;
and wherein the one or more hardware processing devices are further configured to develop the AI Edge Solution by using the query responses.

38. The system of claim 32, further comprising an input device, wherein:
the one or more storage devices are configured to store a plurality of Curated AI Edge Solutions; and
the input device is configured to receive a user selection of one of the Curated AI Edge Solutions;
and wherein the one or more hardware processing devices are further configured to develop the AI Edge Solution by using the user selection.

39. The system of claim 32, wherein the one or more communication devices are further configured to:
receive monitoring data indicative of performance of the AI Edge Solution; and
publish the monitoring data to a third party machine learning observability platform.

40. The system of claim 32, wherein the one or more communication devices are further configured to receive monitoring data indicative of performance of the AI Edge Solution;
and wherein the one or more hardware processing devices are further configured to use the monitoring data to optimize the AI Edge Solution.

41. The system of claim 32, wherein the one or more hardware processing devices are further configured to virtualize a GPU to generate a virtual GPU;
and wherein the one or more communication devices are further configured to allocate utilization of the virtual GPU across a plurality of the Edge Computing Devices.
